(19) United States
(12) Patent Application Publication
(10) Pub. No.: US 2018/0288110 A1
(43) Pub. Date: Oct. 4, 2018

(54) CONFERENCE SUPPORT SYSTEM, CONFERENCE SUPPORT METHOD, PROGRAM FOR CONFERENCE SUPPORT DEVICE, AND PROGRAM FOR TERMINAL

(71) Applicant: HONDA MOTOR CO., LTD., Tokyo (JP)

(72) Inventors: Takashi Kawachi, Wako-shi (JP); Kazuhiro Nakadai, Wako-shi (JP); Tomoyuki Sahata, Tokyo (JP); Yuki Uezono, Hayami-gun (JP); Kazuya Maura, Hayami-gun (JP)

(21) Appl. No.: 15/934,414

(22) Filed: Mar. 23, 2018

(30) Foreign Application Priority Data
Mar. 31, 2017 (JP) 2017-071279

(51) Int. Cl. H04L 29/06; G10L 15/18; G10L 15/22; G10L 15/26; G06F 17/27

(52) U.S. Cl. CPC H04L 65/403; G10L 15/18; G06F 17/2765; G10L 15/265; G10L 15/22

(57) ABSTRACT

A conference support system includes a plurality of terminals which are respectively used by a plurality of participants in a conference, and a conference support device. Each of the plurality of terminals includes an operation unit configured to sets utterance content as an important comment, and an important comment notifying unit configured to notify the other terminals of information indicating the important comment.

### CROSS-REFERENCE TO RELATED APPLICATION

Priority is claimed on Japanese Patent Application No. 2017-071279, filed Mar. 31, 2017, the content of which is incorporated herein by reference.

### BACKGROUND OF THE INVENTION

### Field of the Invention

The present invention relates to a conference support system, a conference support method, a program for a conference support device, and a program for a terminal.

### Description of Related Art

In a case where a plurality of persons participate in a conference, it has been suggested that utterance contents of each utterer be converted into text, and the text be displayed on a reproduction device possessed by each user (refer to Japanese Unexamined Patent Application, First Publication No. H8-194492 (hereinafter, referred to as “Patent Literature 1”). Furthermore, in the technology described in Patent Literature 1, utterance is recorded as a voice memo for every subject, and a person who prepares the minutes reproduces the voice memo that is recorded and converts the voice memo into text. In addition, in the technology described in Patent Literature 1, text that is created is correlated with another text for structuration, thereby preparing the minutes. The prepared minutes are displayed with a reproduction device.

### SUMMARY OF THE INVENTION

However, in actual conversation, a normal-hearing person can understand what is an important comment due to an utterance atmosphere and the like, but there is a problem that it is difficult for a hearing-impaired person such as a person who has difficulty in hearing to understand whether an utterance part is an important comment.

Aspects of the invention have been made in consideration of the above-described problem, and an object thereof is to provide a conference support system, a conference support method, a program for a conference support device, and a program for a terminal which are capable of recognizing information indicating an important comment.

To accomplish the object, the invention employs the following aspects.

(1) According to an aspect of the invention, a conference support system is provided, including: a plurality of terminals which are respectively used by a plurality of participants in a conference; and a conference support device. Each of the plurality of terminals includes an operation unit configured to set utterance content as an important comment, and an important comment notifying unit configured to notify the other terminals of information indicating the important comment.

(2) According to another aspect of the invention, a conference support system is provided, including: a plurality of terminals which are respectively used by a plurality of participants in a conference; and a conference support device. The conference support device includes an acquisition unit configured to acquire utterance, a text correction unit configured to change display of text information corresponding to utterance of the important comment in correspondence with information which is transmitted from the terminals and indicates that the utterance is the important comment, and a communication unit configured to transmit the text information to the plurality of terminals. Each of the plurality of terminals includes a display unit configured to display the text information which is transmitted from the conference support device, an operation unit configured to set the utterance as the important comment, and an important comment notifying unit configured to transmit information indicating that the utterance is the important comment to the conference support device.

(3) In the conference support system according to the aspect (1) or (2), the important comment notifying unit of the terminal may transmit the information indicating that the utterance is the important comment to the conference support device before initiation of the utterance and in termination of the utterance.

(4) In the conference support system according to the aspect (1) or (2), the important comment notifying unit of the terminal may transmit the information indicating that the utterance is the important comment to the conference support device before initiation of the utterance.

(5) In the conference support system according to the aspect (1) or (2), the important comment notifying unit of the terminals may transmit the information indicating that the utterance is the important comment to the conference support device after the utterance.

(6) In the conference support system according to the aspect (2), the conference support device may further include a voice recognition unit configured to recognize voice information and converts the voice information into text information in a case where the utterance content is the voice information, and the acquisition unit, which acquires the utterance, of the conference support device may determine whether the utterance content is voice information or text information.

(7) In the conference support system according to any one of the aspects (1) to (6), after the operation unit is operated, the text correction unit of the conference support device may make the text display different from another text display in color.

(8) In the conference support system according to any one of the aspects (1) to (7), after the operation unit is operated, the important comment notifying unit of the terminal may perform marking with respect to an important comment portion of an object.

(9) According to still another aspect of the invention, a conference support method in a conference support system is provided, including a plurality of terminals which are respectively used by a plurality of participants in a conference. The method includes: allowing an operation unit of each of the plurality of terminals to set utterance content as an important comment; and allowing an important comment notifying unit of the terminal to notify the other terminals of information indicating the important comment.

(10) According to still another aspect of the invention, a conference support method in a conference support system is provided, including a plurality of terminals which are respectively used by a plurality of participants in a conference, and a conference support device. The method includes: allowing an acquisition unit of the conference support device to acquire utterance; allowing a communication unit of the conference support device to transmit text information of the acquired utterance to the plurality of terminals; allowing a display unit of each of the plurality of terminals to display the text information transmitted from the conference support device; allowing an operation unit of the terminal to set the utterance as an important comment; allowing an important comment notifying unit of the terminal to transmit information indicating the utterance is the important comment, to the conference support device; allowing a text correction unit of the conference support device to change display of text information corresponding to utterance of the important comment in correspondence with the information which is transmitted from the terminals and indicates that the utterance is the important comment; and allowing a display unit of the terminal to display the changed text information transmitted from the conference support device.

(11) According to still another aspect of the invention, a program for a conference support device is provided, the program allowing a computer of the conference support device in a conference support system, which includes a plurality of terminals respectively used by a plurality of participants in a conference and the conference support device, to execute: acquiring utterance; transmitting text information of the acquired utterance to the plurality of terminals; and changing display of text information corresponding to utterance of an important comment in correspondence with information which is transmitted from the terminals and indicates that the utterance is the important comment.

(12) According to still another aspect of the invention, a program for a terminal is provided, the program allowing a computer of the terminal in a conference support system, which includes a plurality of the terminals respectively used by a plurality of participants in a conference and a conference support device, to execute: displaying text information, which is transmitted from the conference support device, of utterance by the participants; setting the utterance as an important comment; transmitting information, which indicates that the utterance is the important comment, to the conference support device; and displaying the text information, which is changed and transmitted from the conference support device, in correspondence with the transmission of the information indicating that the utterance is the important comment by a display unit of the plurality of terminals.

According to the aspects (1), (2), (9), (10), (11), and (12), the participants can recognize that utterance is an important comment. In addition, according to the aspects (1), (2), (9), (10), (11), and (12), particularly, a hearing-impaired person and the like can recognize that utterance is an important comment.

According to the aspects (3) and (4), since the participants are notified of the information indicating that utterance is an important comment in the utterance, the participants can recognize that the utterance is the important comment.

According to the aspect (5), since the participants are notified of information indicating that utterance is an important comment after the utterance, the participants can recognize that the utterance is an important comment.

According to the aspect (6), even though utterance is text information, the participants can recognize that the utterance is an important comment.

According to the aspect (7), it is possible to further emphasize an important comment portion in comparison to other comments.

According to the aspect (8), it is possible to further emphasize an important comment in comparison to other comments.

### BRIEF DESCRIPTION OF THE DRAWINGS

FIG. 1 is a block diagram illustrating a configuration example of a conference support system according to a first embodiment;

FIG. 2 is a view illustrating an example of an image that is displayed on a display unit of a terminal according to the first embodiment;

FIG. 3 is a sequence diagram of a procedure example of the conference support system according to the first embodiment;

FIG. 4 is a flowchart illustrating a procedure example that is executed by a terminal according to the first embodiment;

FIG. 5 is a flowchart illustrating a procedure example that is executed by a conference support device according to the first embodiment;

FIG. 6 is a view illustrating an example in which a participant selects text information after utterance and changes display to indicate that the utterance is an important comment according to the first embodiment;

FIG. 7 is a flowchart illustrating a procedure example that is executed by a terminal in a case of setting the important comment after utterance according to the first embodiment;

FIG. 8 is a flowchart illustrating a procedure example that is executed by the conference support device in a case of setting the important comment after utterance according to the first embodiment; and

FIG. 9 is a view illustrating an example of designating and deleting an unnecessary comment according to the first embodiment.

### DETAILED DESCRIPTION OF THE INVENTION

Hereinafter, an embodiment of the invention will be described with reference to the accompanying drawings.

First, description will be given of a situation example in which a conference support system of this embodiment is used.

The conference support system of this embodiment is used in a conference that is performed in a state in which two or more persons participate in the conference. Among participants, a person who is inconvenient in utterance may participate in the conference. Each of utterable participants wears a microphone. In addition, the participants may carry a terminal (a smartphone, a tablet terminal, a personal computer, and the like). The conference support system performs voice recognition and conversion into text with respect to voice signals uttered by the participants, and displays the text on the terminal.

In addition, when performing important utterance, a user initiates the utterance after operating the terminal, or gives an instruction for application of a marker and the like in the text that is displayed on the terminal after the utterance. The conference support system notifies the terminal of the entirety of the participants of information indicating important utterance in correspondence with the operation.

### First Embodiment

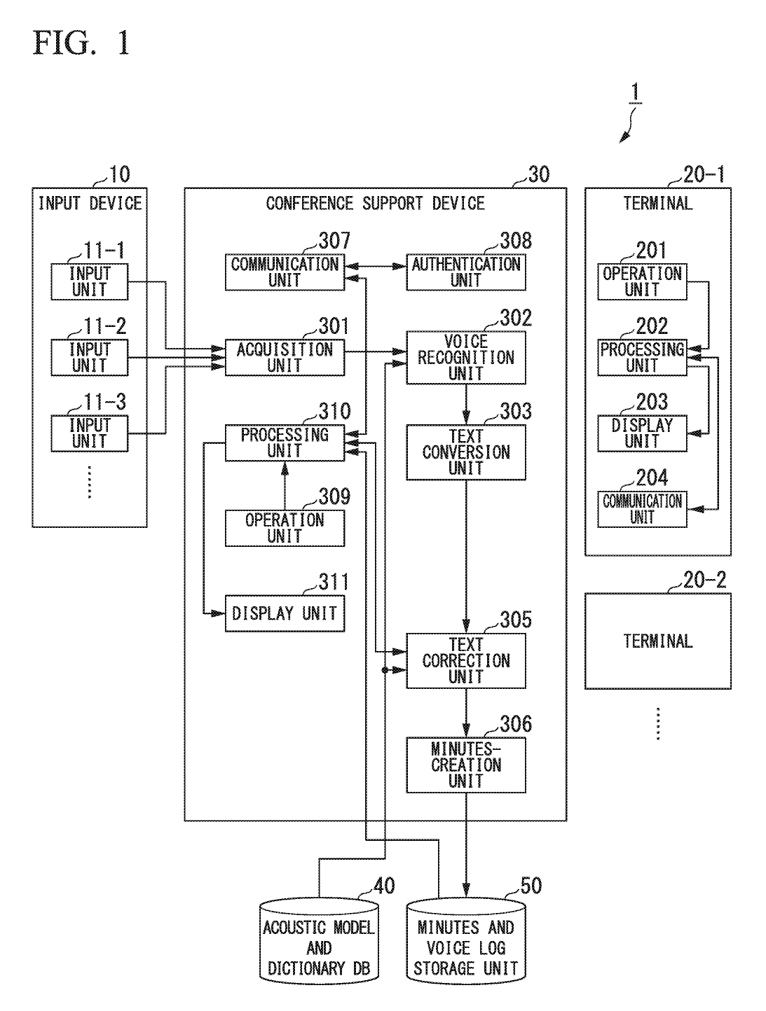

FIG. 1 is a block diagram illustrating a configuration example of a conference support system 1 according to this embodiment.

First, description will be given of a configuration of the conference support system 1.

As illustrated in FIG. 1, the conference support system 1 includes an input device 10, a terminal 20, a conference support device 30, an acoustic model and dictionary DB 40, and a minutes and voice log storage unit 50. In addition, the terminal 20 includes a terminal 20-1, a terminal 20-2, . . . . In a case of not specifying one of the terminal 20-1 and the terminal 20-2, the terminals are collectively referred to as “terminal 20”.

The input device 10 includes an input unit 11-1, an input unit 11-2, an input unit 11-3, . . . . In a case of not specifying one of the input unit 11-1, the input unit 11-2, the input unit 11-3, . . . , the input units are collectively referred to as “input unit 11”.

The terminal 20 includes an operation unit 201, a processing unit 202 (important comment notifying unit), a display unit 203, and a communication unit 204 (important comment notifying unit).

The conference support device 30 includes an acquisition unit 301, a voice recognition unit 302, a text conversion unit 303 (voice recognition unit), a text correction unit 305, a minutes-creation unit 306, a communication unit 307, an authentication unit 308, an operation unit 309, a processing unit 310, and a display unit 311.

The input device 10 and the conference support device 30 are connected to each other in a wired manner or a wireless manner. The terminal 20 and the conference support device 30 are connected to each other in a wired manner or a wireless manner.

First, description will be given of the input device 10.

The input device 10 outputs a voice signal, which is uttered by a user, to the conference support device 30. Furthermore, the input device 10 may be a microphone array. In this case, the input device 10 includes P pieces of microphones which are respectively disposed at positions different from each other. In addition, the input device 10 generates P-channel voice signals (P is an integer of two or greater) from sound that is acquired, and outputs the generated P-channel voice signals to the conference support device 30.

The input unit 11 is a microphone. The input unit 11 acquires voice signals of the user, converts the acquired voice signals from analog signals to digital signals, and outputs the voice signals, which are converted into digital signals, to the conference support device 30. Furthermore, the input unit 11 may output voice signals which are analog signals to the conference support device 30. Furthermore, the input unit 11 may output the voice signals to the conference support device 30 through a wired cord or cable, or may wirelessly transmit the voice signals to the conference support device 30.

Next, description will be given of the terminal 20.

Examples of the terminal 20 include a smart-phone, a tablet terminal, a personal computer, and the like. The terminal 20 may include a voice output unit, a motion sensor, a global positioning system (GPS), and the like.

The operation unit 201 detects an operation by a user, and outputs a detection result to the processing unit 202. Examples of the operation unit 201 include a touch panel type sensor or a keyboard which is provided on the display unit 203.

The processing unit 202 generates transmission information in correspondence with the operation result output from the operation unit 201, and outputs the transmission information, which is generated, to the communication unit 204. The transmission information is one of a participation request indicating desire to participate in the conference, a leaving request indicating desire to leave the conference, information indicating utterance initiation of an important comment, information indicating utterance termination of the important comment, information indicating that text information is selected as the important comment, an instruction for reproduction of the minutes in past conference, and the like. Furthermore, the transmission information includes identification information of the terminal 20. Furthermore, after utterance, in a case where the utterance is selected as an important comment, the processing unit 202 transmits information, which indicates that text information corresponding to the comment is selected as the important comment, to the conference support device 30. In addition, after utterance, in a case where the utterance is selected as an important comment, the processing unit 202 corrects or changes (application of a marker corresponding to display, change of a font size, change of a font color, addition of an underline and the like) text information corresponding to the comment, and transmits the text information, which is corrected, to the conference support device 30. Furthermore, selection of the important comment may be selection of a part of a sentence, a word, and the like. As described above, before the important comment is initiated, when the important comment is terminated (after the important comment is terminated), or when the important comment is selected after utterance termination, the processing unit 202 transmits information indicating the important comment to the conference support device 30 through the communication unit 204 for notification.

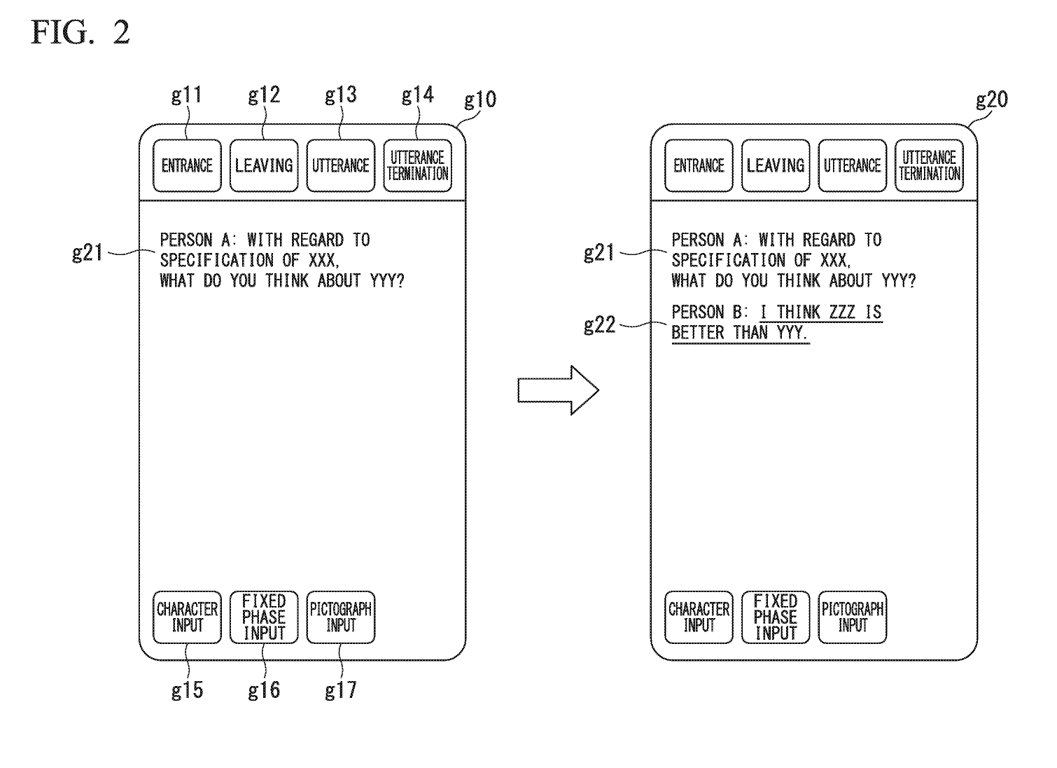

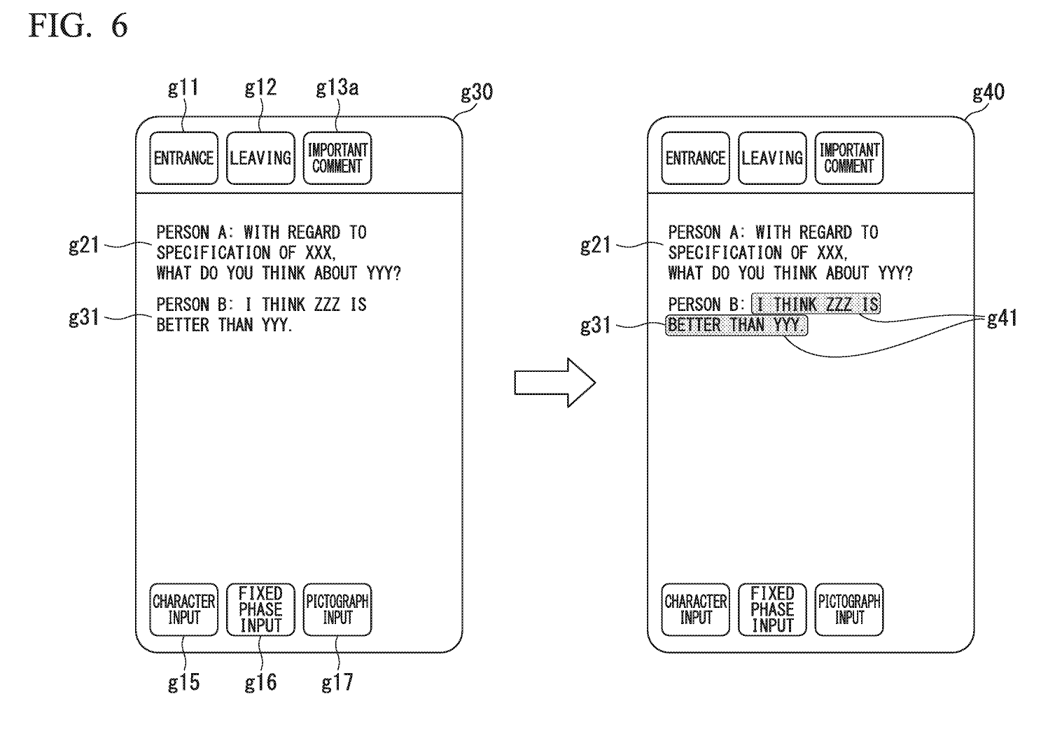

The processing unit 202 acquires the text information output from the communication unit 204, converts the acquired text information into image data, and outputs the converted image data to the display unit 203. Furthermore, the image displayed on the display unit 203 will be described later with reference to FIG. 2 and FIG. 6.

The display unit 203 displays the image data that is output from the processing unit 202. Examples of the display unit 203 include a liquid crystal display device, an organic electroluminescence (EL) display device, an electronic ink display device, and the like.

The communication unit 204 receives text information or information of the minutes from the conference support device 30, and outputs the reception information, which is received, to the processing unit 202. The communication unit 204 transmits instruction information output from the processing unit 202 to the conference support device 30.

Next, description will be given of the acoustic model and dictionary DB 40.

For example, an acoustic model, a language model, a word dictionary, and the like are stored in the acoustic model and dictionary DB 40. The acoustic model is a model based on a feature quantity of a sound, and the language model is a model of information of words and an arrangement type of the words. In addition, the word dictionary is a dictionary of a plurality of words, and examples thereof include a large-vocabulary word dictionary. Furthermore, the conference support device 30 may stores words and the like, which are not stored in the voice recognition dictionary 13, in the acoustic model and dictionary DB 40 for updating thereof.

Next, description will be given of the minutes and voice log storage unit 50.

The minutes and voice log storage unit 50 stores the minutes (included voice signals). The minutes and voice log storage unit 50 may store information indicating an important comment.

Next, description will be given of the conference support device 30.

For example, the conference support device 30 is any one of a personal computer, a server, a smart-phone, a tablet terminal, and the like. Furthermore, in a case where the input device 10 is a microphone array, the conference support device 30 further includes a sound source localization unit, a sound source separation unit, and a sound source identification unit.

The conference support device 30 recognizes voice signals uttered by participants and converts the voice signals into text. In addition, the conference support device 30 transmits text information of utterance contents converted into text to each of a plurality of the terminals 20 of the participants. In addition, when receiving information, which indicates an important comment, as instruction information from the terminals 20 before utterance and after utterance termination, the conference support device 30 corrects the text information and transmits the corrected text information to each of the terminals 20. In addition, when receiving information, which indicates an important comment, as instruction information from the terminals 20 after utterance, the conference support device 30 transmits the corrected text information, which is received as instruction information from the terminals 20, to each of the terminals 20. In addition, when receiving information, which indicates an important comment, as instruction information from the terminals 20 after utterance, the conference support device 30 corrects corresponding text information in correspondence with the information received from the terminals 20, and transmits corrected text information to each of the terminals 20 through the communication unit 307.

The acquisition unit 301 acquires voice signals output from the input unit 11, and outputs the acquired voice signals to the voice recognition unit 302. Furthermore, in a case where the acquired voice signals are analog signals, the acquisition unit 301 converts the analog signals into digital signals, and outputs the voice signals, which are converted into the digital signals, to the voice recognition unit 302.

In a case where a plurality of the input units 11 exist, the voice recognition unit 302 performs voice recognition for every utterer who uses each of the input units 11.

The voice recognition unit 302 acquires the voice signals output from the acquisition unit 301. The voice recognition unit 302 detects a voice signal in an utterance section from the voice signals output from the acquisition unit 301. With regard to detection of the utterance section, for example, a voice signal that is equal to or greater than a predetermined threshold value is detected as the utterance section. Furthermore, the voice recognition unit 302 may perform detection of the utterance section by using other known methods. In addition, the voice recognition unit 302 detects the utterance section by using information indicating utterance initiation of an important comment transmitted from the terminals 20 and information indicating utterance termination of the important comment. The voice recognition unit 302 performs voice recognition with respect to the voice signal in the utterance section that is detected with reference to the acoustic model and dictionary DB 40 by using a known method. Furthermore, the voice recognition unit 302 performs voice recognition by using, for example, a method disclosed in Japanese Unexamined Patent Application, First Publication No. 2015-64554, and the like. The voice recognition unit 302 outputs recognition results and voice signals after the recognition to the text conversion unit 303. Furthermore, the voice recognition unit 302 outputs the recognition results and the voice signals, for example, in correlation with each sentence, each utterance section, or each utterer.

The text conversion unit 303 converts the recognition results output from the voice recognition unit 302 into text. The text conversion unit 303 outputs text information after the conversion, and the voice signals to the text correction unit 305. Furthermore, the text conversion unit 303 may perform the conversion into text after deleting interjections such as “ah”, “um”, “uh”, and “wow”.

The text correction unit 305 corrects display of the text information output from the text conversion unit 303 in correspondence with a correction instruction output from the processing unit 310 through correction of a font color, correction of a font size, correction of the kind of font, addition of an underline to a comment, application of a marker to the comment, and the like. The text correction unit 305 outputs the text information that is output from the text conversion unit 303, or the corrected text information to the processing unit 310. The text correction unit 305 outputs the text information and the voice signals, which are output from the text conversion unit 303, to the minutes-creation unit 306.

The minutes-creation unit 306 creates the minutes on the basis of the text information and the voice signals, which are output from the text correction unit 305, for every utterer. The minutes-creation unit 306 stores voice signals corresponding to the created minutes in the minutes and voice log storage unit 50. Furthermore, the minutes-creation unit 306 may create the minutes after deleting interjections such as “ah”, “um”, “uh”, and “wow”.

The communication unit 307 transmits and receives information to and from the terminals 20. The information, which is received from the terminals 20, includes a participation request, voice signals, instruction information (including information indicating an important comment), an instruction for reproduction of the minutes in past conference, and the like. In response to the participation request received from any one of the terminals 20, the communication unit 307 extracts, for example, an identifier for identification of the terminal 20, and outputs the extracted identifier to the authentication unit 308. Examples of the identifier include a serial number of the terminals 20, a media access control address (MAC address), an internet protocol (IP) address, and the like. In a case where the authentication unit 308 outputs a communication participation permitting instruction, the communication unit 307 performs communication with the terminal 20 that makes a request for participation in a conference. In a case where the authentication unit 308 outputs a communication participation not-permitting instruction, the communication unit 307 does not perform communication with the terminal 20 that makes a request for participation in a conference. The communication unit 307 extracts instruction information from information that is received, and outputs the extracted instruction information to the processing unit 310. The communication unit 307 transmits text information or corrected text information, which is output from the processing unit 310, to the terminal 20 that makes a request for participation in a conference. The communication unit 307 transmits information of the minutes, which is output from the processing unit 310, to the terminal 20 that makes a request for participation in a conference, or a terminal 20 that transmits an instruction for reproduction of the minutes in past conference.

The authentication unit 308 receives the identifier output from the communication unit 307 and determines whether or not to permit communication. Furthermore, for example, the conference support device 30 receives registration of a terminal 20 that is used by a participant in a conference, and registers the terminal 20 in the authentication unit 308. The authentication unit 308 outputs a communication participation permitting instruction or a communication participation not-permitting instruction to the communication unit 307 in correspondence with the determination result.

Examples of the operation unit 309 include a keyboard, a mouse, a touch panel sensor provided on the display unit 311, and the like. The operation unit 309 detects an operation result by a user and outputs a detected operation result to the processing unit 310.

The processing unit 310 creates a correction instruction in correspondence with the instruction information output from the communication unit 307, and outputs the created correction instruction to the text correction unit 305. When receiving information, which indicates an important comment, as instruction information from the terminals 20 before utterance and after utterance termination, the processing unit 310 outputs a correction instruction for correction of text information to the text correction unit 305. Furthermore, when utterance is terminated, even though instruction information indicating the termination is not transmitted, the processing unit 310 may regard that the utterance by an utterer is terminated when voice signals of a predetermined level or higher are not acquired from the input unit 11 for a predetermined time, and may use information indicating utterance termination instead of instruction information. In addition, when receiving information, which indicates an important comment, as instruction information from the terminals 20 after utterance, the processing unit 310 outputs corrected text information, which is received as instruction information from the terminals 20, to the communication unit 307. In addition, when receiving information, which indicates an important comment, as instruction information from the terminals 20 after utterance, the processing unit 310 outputs a correction instruction for correction of corresponding text information to the text correction unit 305 in correspondence with information received from the terminals 20.

The processing unit 310 outputs text information or corrected text information, which is output from the text correction unit 305, to the communication unit 307.

The processing unit 310 reads out the minutes from the minutes and voice log storage unit 50 in correspondence with the instruction information, and outputs information of the read-out minutes to the communication unit 307. Furthermore, the information of the minutes may include information indicating an utterer, information indicating a correction result of the text correction unit 305, and the like.

The display unit 311 displays image data output from the processing unit 310. Examples of the display unit 311 include a liquid crystal display device, an organic EL display device, an electronic ink display device, and the like.

Furthermore, in a case where the input device 10 is a microphone array, the conference support device 30 further includes a sound source localization unit, a sound source separation unit, and a sound source identification unit. In this case, in the conference support device 30, the sound source localization unit performs sound source localization with respect to voice signals acquired by the acquisition unit 301 by using a transfer function that is created in advance. In addition, the conference support device 30 performs utterer identification by using results of the localization by the sound source localization unit. The conference support device 30 performs sound source separation with respect to the voice signals acquired by the acquisition unit 301 by using the results of the localization by the sound source localization unit. In addition, the voice recognition unit 302 of the conference support device 30 performs detection of an utterance section and voice recognition with respect to the voice signals which are separated from each other (for example, refer to Japanese Unexamined Patent Application, First Publication No. 2017-9657). In addition, the conference support device 30 may perform a reverberation sound suppressing process.

In addition, the conference support device 30 may perform morphological analysis and dependency analysis with respect to text information after conversion by the text conversion unit 303.

Next, description will be given of an example of an image that is displayed on the display unit 203 of each of the terminals 20 with reference to FIG. 2.

FIG. 2 is a view illustrating an example of an image that is displayed on the display unit 203 of the terminal 20 according to this embodiment.

First, description will be given of an image g10.

The image g10 is an image example that is displayed on the display unit 203 of the terminal 20 in utterance by a person A. The image g10 includes an entrance button image g11, a leaving button image g12, an important comment button image g13, an utterance termination button image g14, a character input button image g15, a fixed phase input button image g16, a pictograph input button image g17, and an image g21 of an utterance text of the person A.

The entrance button image g11 is an image of a button that is selected when a participant participates in a conference.

The leaving button image g12 is an image of a button that is selected when the participant leaves from the conference or the conference is terminated.

The important comment button image g13 is an image of a button that is selected in a case of initiating important utterance.

The utterance termination button image g14 is an image of a button that is selected in a case of terminating important utterance.

The character input button image g15 is an image of a button that is selected in a case where the participant inputs characters by operating the operation unit 201 of the terminal 20 instead of utterance with a voice.

The fixed phase input button image g16 is an image of a button that is selected when the participant inputs a fixed phase by operating the operation unit 201 of the terminal 20 instead of utterance with a voice. Furthermore, when this button is selected, a plurality of fixed phases are selected, and the participant is selected from the plurality of fixed phases which are displayed. Furthermore, examples of the fixed phases include “good morning”, “good afternoon”, “today is cold”, “today is hot”, “may I go to the bathroom?”, “let's have a break time from now”, and the like.

The pictograph input button image g17 is an image of a button that is selected when the participant inputs a pictograph by operating the operation unit 201 of the terminal 20 instead of utterance with a voice.

The image g21 that is the utterance text of the person A is text information after the voice recognition unit 302 and the text conversion unit 303 process voice signals uttered by the person A.

Next, description will be given of an image g20.

The image g20 is an image example that is displayed on the display unit 203 of each of the terminals 20 after a person B utters an important comment after utterance by the person A. The image g20 includes an image g22 of an utterance text of the person B in addition to the image g10.

The example illustrated in FIG. 2 is an example in which the utterance by the person A is not an important comment, and a comment of the person B is an important comment. Accordingly, the image g22 is also an example in which text information is corrected through correction of a font color and addition of an underline differently from the image g21. Furthermore, with regard to a display method of the important comment, for example, coloring may be performed with a marker.

In addition, in the example illustrated in FIG. 2, description has been given of an example of buttons displayed on the display unit 203, but the buttons may be physical buttons (operation unit 201).

Next, description will be given of a procedure example of the conference support system 1.

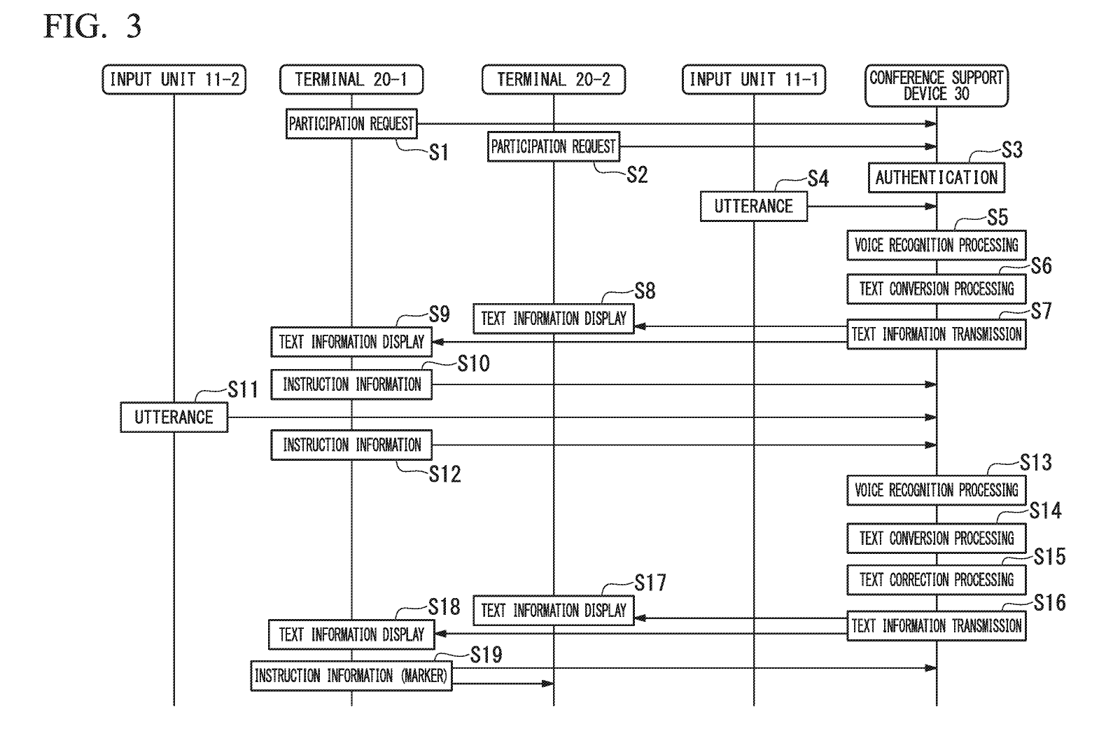

FIG. 3 is a sequence diagram of the procedure example of the conference support system 1 according to this embodiment.

The example illustrated in FIG. 3 is an example in which three participants (users) participate in a conference. A participant A is a user of the conference support device 30 and wears the input unit 11-1. A participant B is a user of the terminal 20-1 and wears the input unit 11-2. A participant C is a user of the terminal 20-2 and does not wear the input unit 11. For example, it is assumed that the participant B and the participant C are hearing-impaired person such as a person who has difficulty in hearing.

(Step S1)

The user B selects the entrance button image g11 (FIG. 2) by operating the operation unit 201 of the terminal 20-1 to participate in a conference. The processing unit 202 of the terminal 20-1 transmits a participation request to the conference support device 30 in correspondence with a result in which the entrance button image g11 is selected by the operation unit 201.

(Step 2)

The participant C selects the entrance button image g11 by operating the operation unit 201 of the terminal 20-2 to participate in the conference. The processing unit 202 of the terminal 20-2 transmits a participation request to the conference support device 30 in correspondence with a result in which the entrance button image g11 is selected by the operation unit 201.

(Step 3)

The communication unit 307 of the conference support device 30 receives the participation requests which are respectively transmitted from the terminal 20-1 and the terminal 20-2. Continuously, the communication unit 307 extracts, for example, an identifier for identifying the terminals 20 from the participation requests received from the terminals 20. Continuously, the authentication unit 308 of the conference support device 30 receives the identifier that is output from the communication unit 307, and performs identification as to whether or not to permit communication. The example illustrated in FIG. 3 is an example in which participation of the terminal 20-1 and the terminal 20-2 is permitted.

(Step S4)

The participant A performs utterance. The input unit 11-1 outputs voice signals to the conference support device 30.

(Step S5)

The voice recognition unit 302 of the conference support device 30 performs voice recognition processing with respect to the voice signals output from the input unit 11-1 (voice recognition processing).

(Step S6)

The text conversion unit 303 of the conference support device 30 converts the voice signals into text (text conversion processing).

(Step S7)

The processing unit 310 of the conference support device 30 transmits text information to each of the terminal 20-1 and the terminal 20-2 through the communication unit 307.

(Step S8)

The processing unit 202 of the terminal 20-2 receives the text information, which is transmitted from the conference support device 30, through the communication unit 204, and displays the received text information on the display unit 203 of the terminal 20-2.

(Step S9)

The processing unit 202 of the terminal 20-1 receives the text information, which is transmitted from the conference support device 30, through the communication unit 204, and displays the received text information on the display unit 203 of the terminal 20-1.

(Step S10)

The participant B operates the operation unit 201 of the terminal 20-1 before utterance to select the important comment button image g13 (FIG. 2). Continuously, the processing unit 202 of the terminal 20-1 transmits instruction information, which includes information indicating initiation of an important comment, to the conference support device 30 in correspondence with the operation of the operation unit 201.

(Step S11)

The participant B performs utterance. The input unit 11-2 transmits voice signals to the conference support device 30.

(Step S12)

When the utterance is terminated, the participant B operates the operation unit 201 of the terminal 20-1 to select utterance termination button image g14 (FIG. 2). Continuously, the processing unit 202 of the terminal 20-1 transmits instruction information, which includes information indicating the termination of the important comment, to the conference support device 30 in correspondence with the operation of the operation unit 201.

(Step S13)

The voice recognition unit 302 of the conference support device 30 performs voice recognition processing with respect to the voice signals transmitted from the input unit 11-2.

(Step S14)

The text conversion unit 303 of the conference support device 30 converts the voice signals into text.

(Step S15)

The text correction unit 305 of the conference support device 30 corrects the text information in correspondence with the instruction information transmitted from the terminal 20-1. For example, as in the image g22 in FIG. 2, the text correction unit 305 changes a font color of the text information of the utterance by the participant B and adds an underline.

(Step S16)

The processing unit 310 of the conference support device 30 transmits the corrected text information to the terminal 20-1 and the terminal 20-2 through the communication unit 307.

(Step S17)

The processing unit 202 of the terminal 20-2 performs processing in the same manner as in step S8.

(Step S18)

The processing unit 202 of the terminal 20-1 performs processing in the same manner as in step S9.

The processing executed by the conference support system 1 is terminated after the above-described steps. Processing in step S19 will be described later.

Next, description will be given of a procedure example that is executed by the terminal 20.

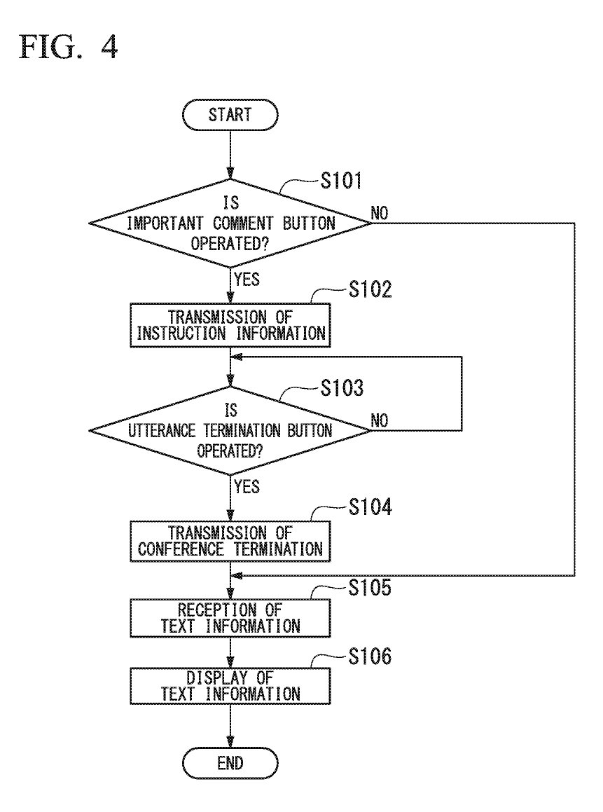

FIG. 4 is a flowchart illustrating a procedure example that is executed by the terminals 20 according to this embodiment.

(Step S101)

The processing unit 202 determines whether or not the operation unit 201 is operated and the important comment button image g13 (FIG. 2) is operated. In a case where it is determined that the important comment button is operated (YES in step S101), the processing unit 202 proceeds to processing in step S102. In addition, in a case where it is determined that the important comment button is not operated (NO in step S101), the processing unit 202 proceeds to processing in step S105. A participant initiates utterance. Continuously, the input device 10 outputs a voice signal, which is uttered, to the conference support device 30.

(Step S102)

The processing unit 202 transmits instruction information, which includes information indicating utterance initiation of an important comment, to the conference support device 30 for notification.

(Step S103)

The processing unit 202 determines whether or not the operation unit 201 is operated and the utterance termination button image g14 (FIG. 2) is operated. In a case where it is determined that the utterance termination button is operated (YES in step S103), the processing unit 202 proceeds to processing in step S104, and in a case where it is determined that the utterance termination button is not operated (NO in step S103), the processing unit 202 repeats the processing in step S103.

(Step S104)

The processing unit 202 transmits instruction information, which includes information indicating utterance termination of the important comment, to the conference support device 30 for notification.

(Step S105)

The processing unit 202 receives the text information or the text information after correction which is transmitted from the conference support device 30.

(Step S106)

The processing unit 202 displays the text information or the text information after correction, which is received, on the display unit 203.

The processing executed by the terminals 20 is terminated after the above-described steps.

Next, description will be given of a procedure example that is executed by the conference support device 30.

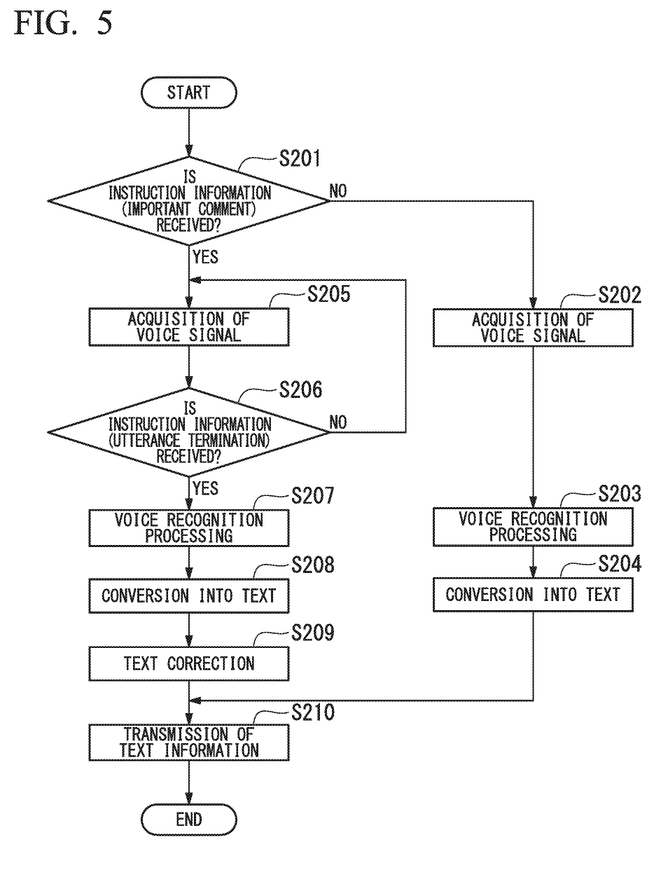

FIG. 5 is a flowchart illustrating a procedure example that is executed by the conference support device 30 according to this embodiment.

(Step S201)

The processing unit 310 determines whether or not instruction information, which includes information indicating utterance initiation of an important comment, is received from the terminals 20. In a case where it is determined that the instruction information is not received (NO in step S201), the processing unit 310 allows processing to proceed to step S202, and in a case where it is determined that the instruction information is received (YES in step S201), the processing unit 310 proceeds to processing in step S205.

(Step S202)

The acquisition unit 301 acquires voice signals output from the input device 10.

(Step S203)

The voice recognition unit 302 performs voice recognition processing with respect to the voice signals which are acquired.

(Step S204)

The text conversion unit 303 converts utterance contents into text on the basis of a voice recognition result (conversion into text). After the processing, the text conversion unit 303 proceeds to processing in step S210.

(Step S205)

The acquisition unit 301 acquires voice signals output from the input device 10.

(Step S206)

The processing unit 310 determines whether or not instruction information, which includes information indicating utterance termination of an important comment, is received from the terminals 20. In a case where it is determined that the instruction information is not received (NO in step S206), the processing unit 310 returns to the processing in step S205, and in a case where it is determined that the instruction information is received (YES in step S206), the processing unit 310 proceeds to processing in step S207.

(Step S207)

The voice recognition unit 302 performs voice recognition processing with respect to the voice signals which are acquired.

(Step S208)

The text conversion unit 303 converts utterance contents into text on the basis of a voice recognition result.

(Step S209)

The text correction unit 305 changes display of text information (text correction). For example, as illustrated in FIG. 2, the text correction unit 305 performs correction by changing a font color of text information of an important comment, and by adding an underline.

(Step S210)

The processing unit 310 transmits the text information or the corrected text information to the terminals 20.

The processing executed by the conference support device 30 is terminated after the above-described steps.

Furthermore, in the example illustrated in FIG. 2, description has been given of an example in which the important comment button is set, and utterance after operation of the button is displayed after performing coloring and the like with respect to text, but there is no limitation to the example. After performing voice recognition processing and conversion into text after utterance, an utterer may perform marking with respect to an important comment portion.

Next, description will be given of an example in which a participant selects text information after utterance, and changes display so as to indicate that the utterance is an important comment.

FIG. 6 is a view illustrating an example in which a participant selects text information after utterance and changes display so as to indicate that the utterance is an important comment according to this embodiment.

An image g30 is an image example that is displayed on the display unit 203 of the terminals 20 when the person B utters after utterance by the person A. The image g30 includes an entrance button image g11, a leaving button image g12, an important comment selection button image g13a, a character input button image g15, a fixed phase input button image g16, a pictograph input button image g17, an image g21 of an utterance text of the person A, and an image g31 of an utterance text of the person B.

The important comment selection button image g13a is an image of a button that is selected in a case where utterance is an important comment after the utterance. Furthermore, in the selection, a part of the utterance, a word, and the like may be selected. For example, in the image g31, when a user touches a region of “person B: I think ZZZ is better than YYY.”, the processing unit 202 selects the entirety of utterance. In addition, when touching “ZZZ”, the processing unit 202 selects a word “ZZZ”. Furthermore, the selection may be performed by an utterer, or other participants.

An image g40 is an image example that is displayed on the display unit 203 of the terminals 20 when utterance contents uttered by the person B are selected as an important comment.

The image g40 is an example in which the entirety of utterance by the person B is selected, and as a result, a marker (image g41) is applied to text information of the image 31 “I think ZZZ is better than YYY”.

Furthermore, selection of the important comment after utterance as illustrated in FIG. 6 may be performed when the minutes are displayed on the terminals 20 after conference is terminated.

Next, description will be given of a procedure example that is executed by the terminals 20 in a case of setting an important comment after utterance.

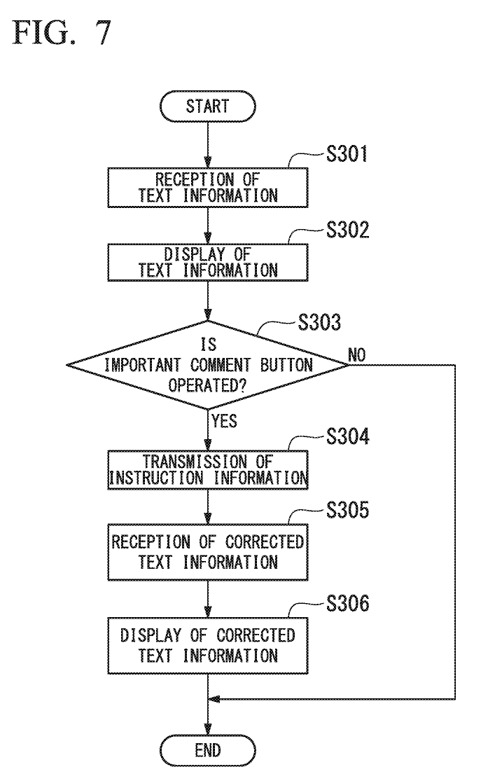

FIG. 7 is a flowchart illustrating a procedure example that is executed by the terminals 20 in a case of setting the important comment after utterance according to this embodiment. Furthermore, the example illustrated in FIG. 7 is an example in which application of a marker is performed by the processing unit 202 of the terminals 20. In addition, the example is also an example in which a user of a terminal 20-1 selects the important comment, and notifies the selection of a user of another terminal 20-2.

(Step S301)

The processing unit 202 of the terminal 20-1 receives text information or text information after correction which is transmitted from the conference support device 30.

(Step S302)

The processing unit 202 of the terminal 20-1 displays the text information or the text information after correction, which is received, on the display unit 203.

(Step S303)

The processing unit 202 of the terminal 20-1 determines whether or not the operation unit 201 is operated and the important comment button image g13a (FIG. 6) is operated. In a case where it is determined that the important comment button is operated (YES in step S303), the processing unit 202 of the terminal 20-1 proceeds to processing in step S304, and in a case where it is determined that the important comment button is not operated (NO in step S303), the processing unit 202 terminates the processing.

(Step S304)

The processing unit 202 of the terminal 20-1 transmits text information that is corrected by an utterer applying a marker to a comment, and instruction information which includes information indicating an important comment to the conference support device 30 for notification.

(Step S305)

The processing unit 202 of the terminal 20-2 receives the text information after correction which is transmitted from the conference support device 30.

(Step S406)

The processing unit 202 of the terminal 20-2 displays the received text information after correction on the display unit 203. According to this, the image g40 in FIG. 6 is also displayed on the display unit 203 of the other terminal 20-2.

The processing executed by the terminals 20 is terminated after the above-described steps.

Next, description will be given of a procedure example that is executed by the conference support device 30 in a case of setting an important comment after utterance.

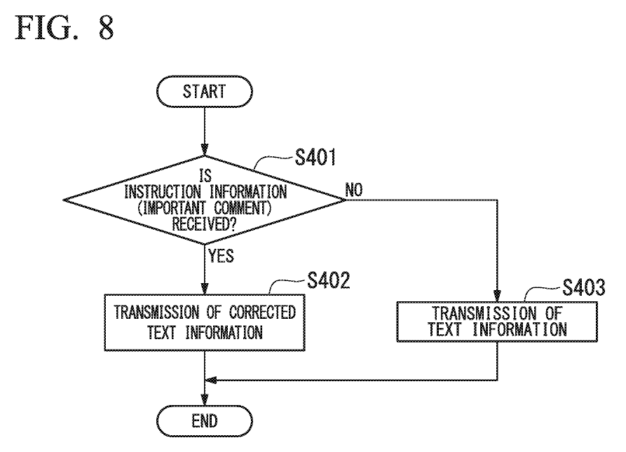

FIG. 8 is a flowchart illustrating a procedure example that is executed by the conference support device 30 in a case of setting the important comment after utterance according to this embodiment.

(Step S401)

The processing unit 310 determines whether or not corrected text information and instruction information, which includes information indicating an important comment, are received from the terminal 20-1. In a case where it is determined that the instruction information is not received (NO in step S401), the processing unit 310 proceeds to processing in step S403, and in a case where it is determined that the instruction information is received (YES in step S401), the processing unit 310 proceeds to processing in step S402. Furthermore, the processing unit 310 identifies a terminal 20 that transmits the instruction information on the basis of identification information that is included in the instruction information.

(Step S402)

The processing unit 310 transmits corrected text information, which is received, to the terminal 20-2 other than the terminal 20-1 from which the corrected text information is transmitted through the communication unit 307. Furthermore, the processing unit 310 may also transmit the corrected text information, which is received, to the terminal 20-1.

(Step S403)

The processing unit 310 transmits the text information to the terminals 20 through the communication unit 307.

The processing that is executed by the conference support device 30 is terminated after the above-described steps.

Furthermore, the processing unit 202 of the terminals 20 may transmits corrected (changed) text information to other terminals 20 other than a terminal 20 from which the instruction information is transmitted as in step S19 in FIG. 3. In addition, as in step S19 in FIG. 3, the processing unit 202 may also transmit the corrected (changed) text information to the conference support device 30.

Furthermore, in the example illustrated in FIG. 7 and FIG. 8, description has been given of an example in which the processing unit 202 of the terminals 20 changes display of text information in a case where the text information is an important comment, but the processing unit 310 of the conference support device 30 may change the display. In this case, the processing unit 202 of the terminals 20 may transmit instruction information, which includes information indicating that a comment is changed, to the conference support device 30. In addition, the processing unit 310 of the conference support device 30 may output a correction instruction to the text correction unit 305 in correspondence with information that is received, and the text correction unit 305 may transmit corrected text information to each of the terminals 20.

In addition, in the above-described example, description has been given of an example in which display is changed to give a notification of an important comment in a case where utterance is the important comment, but an utterer may designate and delete an unnecessary comment.

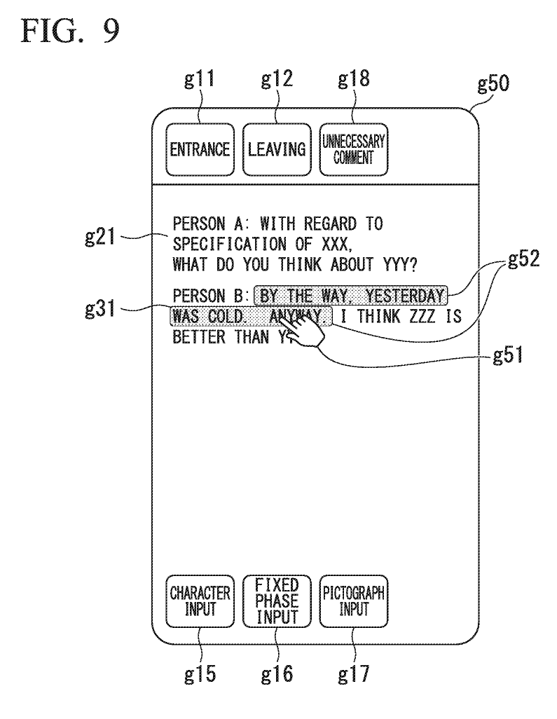

FIG. 9 is a view illustrating an example of designating and deleting an unnecessary comment according to this embodiment.

An image g50 includes an entrance button image g11, a leaving button image g12, a character input button image g15, a fixed phase input button image g16, a pictograph input button image g17, an unnecessary comment button image g18, an image g21 of an utterance text of the person A, an image g31 of an utterance text of the person B, and a comment selection icon image g51.

The unnecessary comment button image g18 is an image of a button that is used to select and delete an unnecessary comment in text information. When the unnecessary comment button image g18 is selected, the processing unit 202 displays the comment selection icon image g51 on the display unit 203.

The comment selection icon image g51 is an image of an icon that is used to select an unnecessary part in the text information.

The example illustrated in FIG. 9 is an example in which ““By the way, yesterday was cold. Anyway.” is selected in “By the way, yesterday was cold. Anyway. I think ZZZ is better than YYY” in utterance by the person B. Correction of display of the comment that is selected is performed by the processing unit 202 of the terminals 20. In addition, the text correction unit 305 of the conference support device 30 may perform the correction.

In a case where the unnecessary comment exists, the text correction unit 305 of the conference support device 30 output text information, from which the unnecessary comment is deleted, to the minutes-creation unit 306. According to this, it is also possible to delete the unnecessary comment from the minutes.

Furthermore, in the above-described example, description has been given of an example in which conversion into a Japanese text is performed in a case where utterance is the Japanese language, but the text conversion unit 303 may translate the text into text of a language different from the uttered language by using a known translation method. In this case, a language that is displayed on each of the terminals 20 may be selected by a user of the terminal 20. For example, Japanese text information may be displayed on the display unit 203 of the terminal 20-1, and English text information may be displayed on the display unit 203 of the terminal 20-2.

In addition, in the above-described example, description has been given of an example in which instruction information indicating an important comment is transmitted to other terminals 20 through the conference support device 30, but there is no limitation to the example. In a case of applying a marker to the important comment after utterance, the processing unit 202 of a terminal 20, which applies the marker, may directly transmit corrected text information to the other terminals 20 in addition to the conference support device 30 for notification.

Hereinbefore, in this embodiment, as illustrated in FIG. 2, FIG. 4, and FIG. 5, the terminals 20 are provided with the important comment button and the utterance termination button, and with respect to utterance in operation of the button, text is colored to notify the terminals 20 used by participants of information indicating that the utterance is an important comment.

In addition, in this embodiment, among contents which are translated (converted) into text, an utterer performs marking with respect to an important comment portion, and notifies the terminals 20 used by participants of information indicating that the utterance is an important comment.

As a result, according to this embodiment, the participants can recognize that utterance is an important comment. According to this embodiment, particularly, a hearing-impaired person and the like can recognize that utterance is an important comment due to display on the terminals 20.

In addition, according to this embodiment, the participants are notified of information indicating that utterance is an important comment in the utterance, and thus the participants can recognize that the utterance is an important comment.

In addition, according to this embodiment, information indicating that utterance is an important comment is given in notification after the utterance, and thus the participants can recognize that the utterance is an important comment.

In addition, according to this embodiment, display is corrected (a font color, an underline, a marker, a font size, and the like) with respect to an important comment, and thus it is possible to further emphasize an important comment portion in comparison to other comments.

In addition, according to this embodiment, display is corrected (a font color, an underline, a marker, a font size, and the like) with respect to an important comment, and thus it is possible to further emphasize the important comment in comparison to other comments.

### Second Embodiment

In the first embodiment, description has been given of an example in which a signal acquired by the acquisition unit 301 is a voice signal, but the information that is acquired may be text information. This case will be described with reference to FIG. 1.

The input unit 11 is a microphone or a keyboard (including a touch panel type keyboard). In a case where the input unit 11 is the microphone, the input unit 11 acquires voice signals of a participant, converts the acquired voice signals from analog signals to digital signals, and outputs the voice signals, which are converted into the digital signals, to the conference support device 30. In a case where the input unit 11 is the keyboard, the input unit 11 detects an operation by a participant, and outputs text information of a detected result to the conference support device 30. In a case where the input unit 11 is the keyboard, the input unit 11 may be the operation unit 201 of the terminals 20. Furthermore, the input unit 11 may output the voice signals or the text information to the conference support device 30 through a wired cord or cable, or may wirelessly transmit the voice signals or the text information to the conference support device 30. In a case where the input unit 11 is the operation unit 201 of the terminals 20, for example, as illustrated in FIG. 2, a participant performs an operation by selecting the character input button image g15, the fixed phase input button image g16, and the pictograph input button image g17. Furthermore, in a case where the character input button image g15 is selected, the processing unit 202 of the terminals 20 displays an image of a software keyboard on the display unit 203.

The acquisition unit 301 determines whether information that is acquired is voice signals or text information. In a case where the information is determined as the text information, the acquisition unit 301 outputs the text information, which is acquired, to the text correction unit 305 through the voice recognition unit 302 and the text conversion unit 303.

In this embodiment, even in a case where the text information is input as described above, the text information is displayed on the display unit 203 of the terminals 20.

As a result, according to this embodiment, even in a case where an input is text information, it is possible to attain the same effect as in the first embodiment.

Furthermore, a program for realization of the entire functions or partial functions of the conference support system 1 in the invention may be recorded on a computer-readable recording medium, and the program recorded on the recording medium may be read-out to a computer system and may be executed therein to perform the entirety or a part of the processing executed by the conference support system 1. Furthermore, it is assumed that the “computer system” stated here includes hardware such as an OS and a peripheral device. In addition, it is assumed that the “computer system” also includes a WWW system including a homepage providing environment (or a display environment). In addition, the “computer-readable recording medium” represents a portable medium such as a flexible disk, a magneto-optical disc, a ROM, and a CD-ROM, and a storage device such as a hard disk that is embedded in the computer system. In addition, it is assumed that the “computer-readable recording medium” also includes a medium such as a volatile memory (RAM), which retains a program for a predetermined time, inside the computer system that becomes a server or a client in a case where the program is transmitted through a network such as the Internet or a communication line such as a telephone line.

In addition, the program may be transmitted from a computer system in which the program is stored in a storage device and the like to other computer systems through a transmission medium, or transmission waves in the transmission medium. Here, the “transmission medium”, through which the program is transmitted, represents a medium having a function of transmitting information similar to a network (communication network) such as the Internet and a communication line such as a telephone line. In addition, the program may be a program configured to realize a part of the above-described functions. In addition, the program may be a so-called differential file (differential program) capable of being realized in combination with a program that is recorded in advance in a computer system having the above-described functions.

What is claimed is:

1. A conference support system, comprising:
a plurality of terminals which are respectively used by a plurality of participants in a conference; and
a conference support device,
wherein each of the plurality of terminals includes,
an operation unit configured to set utterance content as an important comment, and
an important comment notifying unit configured to notify the other terminals of information indicating the important comment.

2. The conference support system according to claim 1,
wherein the important comment notifying unit of the terminal transmits the information indicating that the utterance is the important comment to the conference support device before initiation of the utterance and in termination of the utterance.

3. The conference support system according to claim 1,
wherein the important comment notifying unit of the terminal transmits the information indicating that the utterance is the important comment to the conference support device before initiation of the utterance.

4. The conference support system according to claim 1,
wherein the important comment notifying unit of the terminals transmits the information indicating that the utterance is the important comment to the conference support device after the utterance.

5. The conference support system according to claim 1,
wherein after the operation unit is operated, the text correction unit of the conference support device makes the text display different from another text display in color.

6. The conference support system according to claim 1,
wherein after the operation unit is operated, the important comment notifying unit of the terminal performs marking with respect to an important comment portion of an object.

7. A conference support system, comprising:
a plurality of terminals which are respectively used by a plurality of participants in a conference; and
a conference support device,
wherein the conference support device includes,
an acquisition unit configured to acquire utterance,
a text correction unit configured to change display of text information corresponding to utterance of the important comment in correspondence with information which is transmitted from the terminals and indicates that the utterance is the important comment, and
a communication unit configured to transmit the text information to the plurality of terminals, and
wherein each of the plurality of terminals includes,
a display unit configured to display the text information which is transmitted from the conference support device,
an operation unit configured to set the utterance as the important comment, and
an important comment notifying unit configured to transmit information indicating that the utterance is the important comment to the conference support device.

8. The conference support system according to claim 7,
wherein the conference support device further includes a voice recognition unit configured to recognize voice information and converts the voice information into text information in a case where the utterance content is the voice information, and
the acquisition unit, which acquires the utterance, of the conference support device determines whether the utterance content is voice information or text information.

9. A conference support method in a conference support system including a plurality of terminals which are respectively used by a plurality of participants in a conference, and a conference support device, the method comprising:
allowing an acquisition unit of the conference support device to acquire utterance;
allowing a communication unit of the conference support device to transmit text information of the acquired utterance to the plurality of terminals;
allowing a display unit of each of the plurality of terminals to display the text information transmitted from the conference support device;
allowing an operation unit of the terminal to set the utterance as an important comment;
allowing an important comment notifying unit of the terminal to transmit information indicating the utterance is the important comment to the conference support device;
allowing a text correction unit of the conference support device to change display of text information corresponding to utterance of the important comment in correspondence with the information which is transmitted from the terminals and indicates that the utterance is the important comment; and
allowing a display unit of the terminal to display the changed text information transmitted from the conference support device.
